(19) United States
(12) Patent Application Publication
(10) Pub. No.: US 2012/0235640 A1
(43) Pub. Date: Sep. 20, 2012

(54) ENERGY MANAGEMENT SYSTEMS AND METHODS

(75) Inventors: Wade BRIDGES, Bloomfield, MI (US); Rick Rajaie, Rochester Hills, MI (US)

(73) Assignee: Fisker Automotive, Inc.

(21) Appl. No.: 13/421,724

(22) Filed: Mar. 15, 2012

Related U.S. Application Data
(60) Provisional application No. 61/453,596, filed on Mar. 17, 2011.

(51) Int. Cl. H02J 7/00

(52) U.S. Cl. 320/109

(57) ABSTRACT

A charger and rechargeable energy storage system for a vehicle includes an on-board charging module and a rechargeable energy storage system having a rechargeable energy storage device. The on-board charging module is physically integrated with the rechargeable energy storage system and thermally integrated with the rechargeable energy storage system by a cooling loop, such that waste heat generated by the on-board charging module is reused to warm the rechargeable energy storage device. An optional bypass valve, such as, an electronically controlled bypass valve, can also be connected to the cooling loop to reduce the overall coolant pressure drop when the vehicle is in a drive operational mode.

### CROSS-REFERENCE TO RELATED PATENT APPLICATIONS

This application claims priority to U.S. Provisional Application No. 61/453,596, filed Mar. 17, 2011, incorporated herein by references in its entirety.

### BACKGROUND

The present disclosure relates generally to a vehicle, and more particularly to energy management systems and methods for a vehicle.

### DESCRIPTION OF THE RELATED ART

Electric vehicles and hybrid electric vehicles use motors to convert electrical energy into kinetic energy. Electric vehicles utilize electric motors exclusively for propulsion. Hybrid electric vehicles (HEVs) utilize one or more electric motors in combination with a conventional powertrain, such as, an internal combustion engine, for propulsion. The electric motors of electric and hybrid electric vehicles may receive their power from a number of sources including fossil fuels, nuclear power, or renewable sources such as solar power, wind power, or the like.

These electric vehicles typically include various power electronic (PE) devices, such as, an on-board charging module (OBCM), a traction power inverter module (TPIM), a DC/DC converter, motors, or the like. The power electronic devices are integrated together by a cooling system. The cooling system includes a power electronic radiator having a power electronic coolant loop including an electrical pump that toggles the loop between on and off positions. These electric vehicles also typically include a rechargeable energy storage system (RESS) or device, such as, a battery. The rechargeable energy storage system has its own unique cooling system. The rechargeable energy storage system cooling system includes a radiator having a cooling loop including an electrical pump that toggles the loop between on and off positions.

The power electronic devices and the rechargeable energy storage system either generate or do not generate heat depending on the operation mode of the vehicle. For example, when the vehicle is in a grid charge operation mode the on-board charging module, DC/DC converter, and rechargeable energy storage system generate heat while the traction power inverter module and motors do not, as shown in FIG. 8. When the vehicle is in a drive operation mode, the traction power inverter module DC/DC converter, motors, and rechargeable energy storage system generate heat while the on-board charging module does not, as shown in FIG. 9. Upon system stabilization, power electronic devices typically operate at a continuous cooling temperature of approximately seventy degrees centigrade (70° C.), while the battery loop typically stabilizes at approximately twenty-five degrees centigrade (25° C.).

While the power electronic cooling system and the rechargeable energy storage system cooling system work, these systems can be inefficient and waste reusable energy. For example, because the on-board charging module is part of the power electronic loop, its waste heat cannot be harvested towards warming up the rechargeable energy storage system itself which could be particularly useful in cold climate conditions and for increasing vehicle EV range.

### SUMMARY

Accordingly, the present disclosure relates to a charger system and rechargeable energy storage system for a vehicle. The system includes an on-board charging module and a rechargeable energy storage system having a rechargeable energy storage device. The on-board charging module may be physically integrated with the rechargeable energy storage system and thermally integrated with the rechargeable energy storage system by a cooling loop, such that waste heat generated by the on-board charging module is reused to warm the rechargeable energy storage device. An optional bypass valve, such as, an electronically controlled bypass valve, can also be connected to the cooling loop to reduce the overall coolant pressure drop when the vehicle is in a drive operational mode.

Also provided is a method of regulating charger system and a rechargeable energy storage system for a vehicle. The method includes providing an on-board charging module and a rechargeable energy storage system having a rechargeable energy storage device. The on-board charging module may be physically integrated with the rechargeable energy storage system and thermally integrated with the rechargeable energy storage system by a cooling loop. The method also includes determining a vehicle operational mode. The method further includes reusing some of the heat generated by the on-board charging module to warm the rechargeable energy storage device. The method may also include using an electronically controlled bypass valve connected to the cooling loop to reduce the overall coolant pressure drop when the vehicle is in a drive operational mode.

An advantage of the present disclosure is that the power electronic cooling system and the rechargeable energy storage system cooling system are more efficient. Another advantage of the present disclosure is that the vehicle EV range can be increased. Still another advantage of the present disclosure is that heat waste from the on-board charger module can be recovered and harnessed to condition the battery in cold days. A further advantage of the present disclosure is that integrating the on-board charger module to the rechargeable energy storage device reduces the number of connections which, in turn, can reduce coolant leaks, electrical connection failures, and improve plumbing and high-voltage cable packaging.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 is an elevated rear perspective view of a vehicle according to various embodiments of the disclosure.

FIG. 2 is a rear perspective view of a vehicle according to various embodiments of the disclosure.

FIG. 3 is a perspective view of a vehicle including an integrated charger and a rechargeable energy storage device system coupled to a vehicle substructure according to various embodiments of the disclosure.

FIG. 4A is an underside view of the integrated charger and rechargeable energy storage system and vehicle substructure according to various embodiments of the disclosure.

FIG. 4B is an underside view of the integrated charger and rechargeable energy storage system and vehicle substructure according to various embodiments of the disclosure.

FIG. 4C is a partial elevated view of the integrated charger and rechargeable energy storage system and vehicle substructure according to various embodiments of the disclosure.

FIG. 5 is a schematic of a power electronic cooling loop and a rechargeable energy storage system cooling loop when the vehicle is operating in a grid charge mode according to various embodiments of the disclosure.

FIG. 6 is a schematic of a power electronic cooling loop and a rechargeable energy storage system cooling loop when the vehicle is operating in a drive mode according to various embodiments of the disclosure.

FIG. 7 is a flow chart of a method of regulating a charger and battery system according to various embodiments of the disclosure.

FIG. 8 is a schematic of a conventional power electronic cooling loop and a rechargeable energy storage system cooling loop when the vehicle is operating in a grid charge mode.

FIG. 9 is a schematic of a conventional power electronic cooling loop and a rechargeable energy storage system cooling loop when the vehicle is operating in a drive mode.

### DESCRIPTION

Various embodiments provide for a power electronic cooling system and a rechargeable energy storage system cooling system that enables the waste heat from the on-board charging module to be harnessed towards warming up the rechargeable energy storage device.

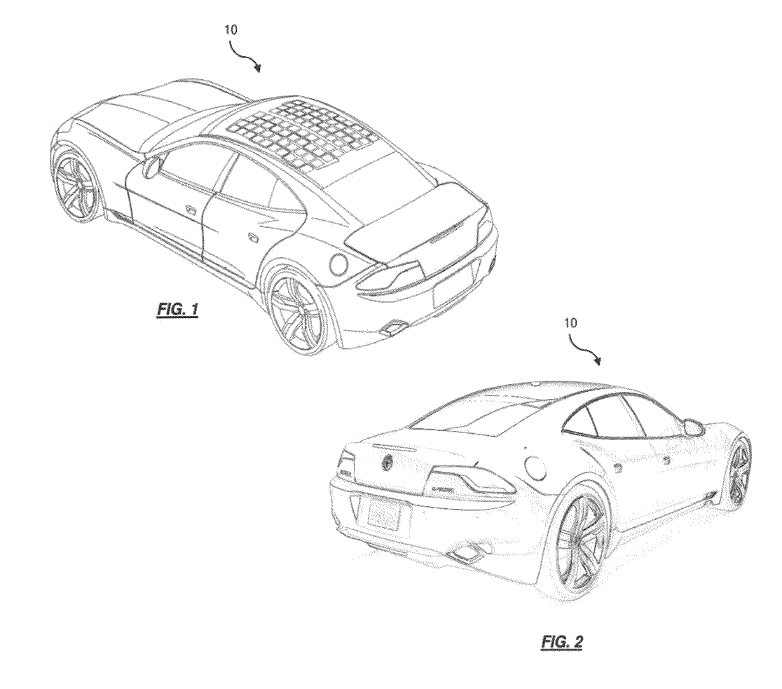

Referring generally to FIGS. 1-2, a vehicle 10 according to various embodiments is shown. While the vehicle 10 shown is a four-door sedan, it should be understood that vehicle 10 may be a two-door sedan, mini-van, sport utility vehicle or any other means in or by which someone travels. In addition, the vehicle 10 may be any type of vehicle, such as an electric vehicle (EV), a hybrid vehicle (HEV), a plug-in hybrid vehicle (PHEV), a vehicle having an internal combustion engine, or the like.

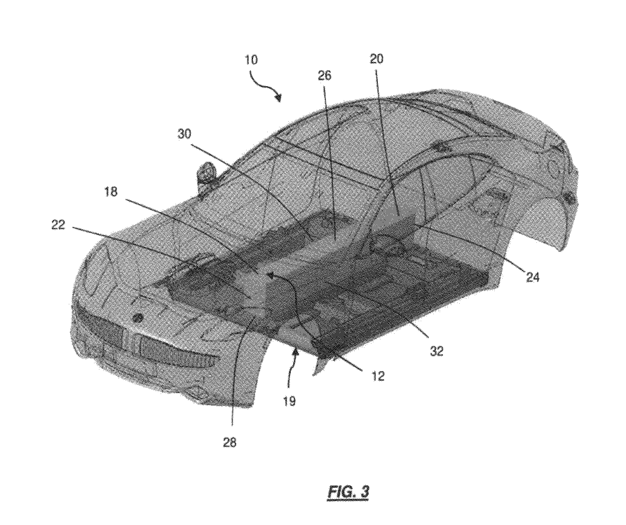

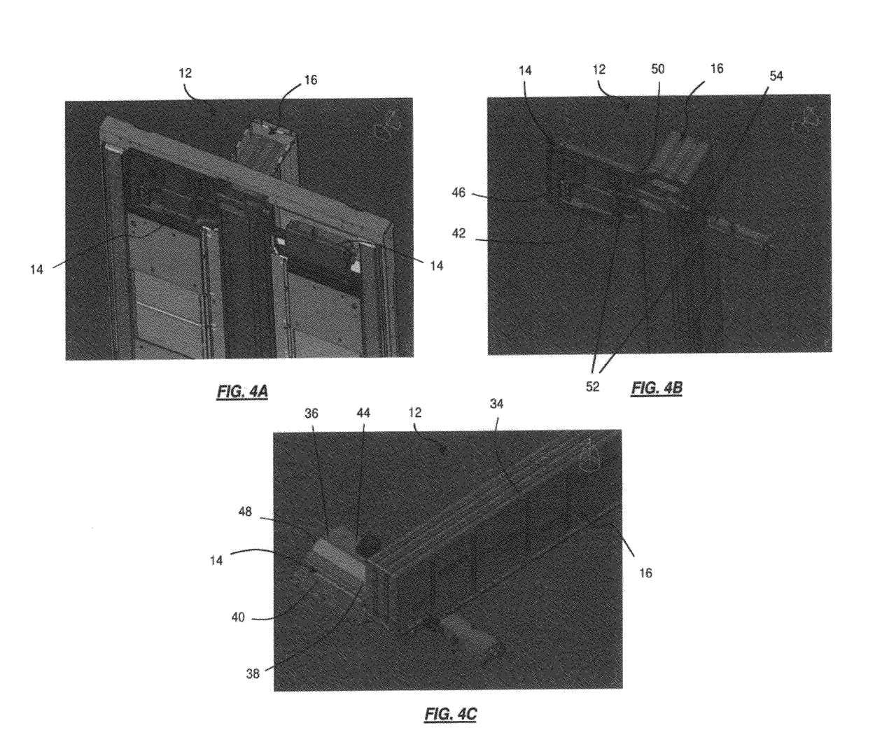

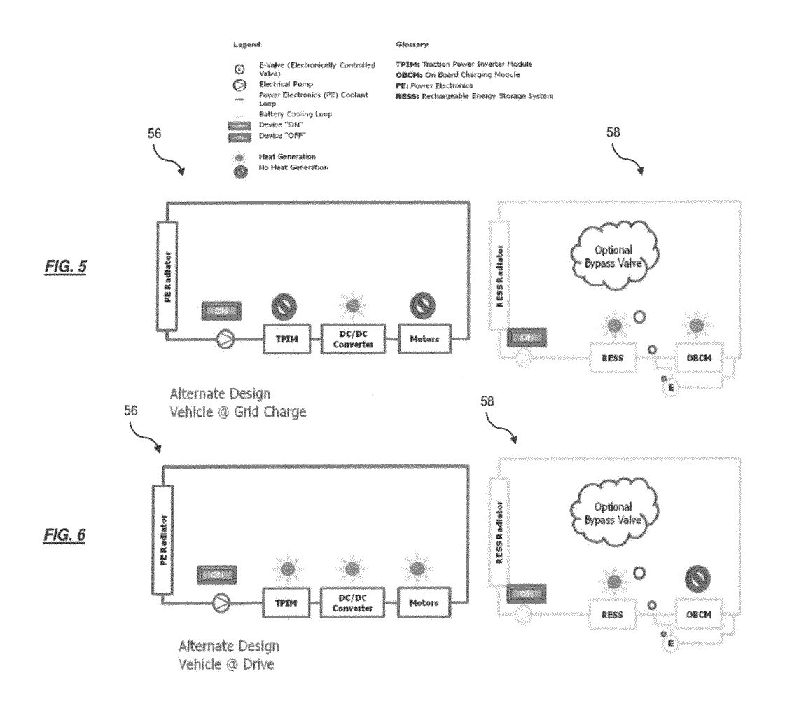

Referring now to FIGS. 3 through 4C, a vehicle 10 having an on-board charging module 14 and rechargeable energy storage system 12 is shown. The rechargeable energy storage system 12 includes a rechargeable energy storage device 16, such as, a battery, or the like.

The rechargeable energy storage device 16 supplies the power in the form of electricity to operate various vehicle components. The rechargeable energy storage device 16 generally has an elongated rectangular shape having a first end 18, an opposed second end 20, a front surface 22, an opposed rear surface 24, a top surface 26, an opposed bottom surface 28, a first side surface 30 and an opposed second side surface 32. The rechargeable energy storage device 16 is at least partially housed in a protective housing or case 34. The housing or case 34 is a generally box-like structure that provides additional protection to the energy storage device 16. The energy storage device 16 is supported within the vehicle 10 by the vehicle's sub structure, and a tray 19, or the like. In some embodiments, the energy storage device 16 and tray 19 extend longitudinally along the length of the vehicle 10. The tray 19 is fabricated from a metal material, such as aluminum or the like. The tray 19 is secured to the vehicle frame using a fastener, such as a bolt, or the like. The housing 34 is secured to the tray 19, such as by using a fastener, or the like. A seal is applied between the tray 19 and the housing 34 to prevent the intrusion of elements such as moisture or dirt or like into the interior of the energy storage device 16. An example of a sealant is rubber, foam, adhesive, or the like.

The rechargeable energy storage device 16 stores electrical energy and may be a single unit, or a plurality of modules arranged in a predetermined manner, such as in series. Various types of batteries may be used as the rechargeable energy storage device 16 may be used, such as, a lead acid battery, a lithium-ion battery, or the like. The vehicle 10 may also include more than one type of energy storage device 16.

For example, the vehicle 10 may include a low voltage battery that provides electrical power to vehicle components such as the various auxiliary systems and a high voltage battery (e.g., 400 V traction battery) that provides electrical power to an electric drive motor. The energy storage device 16 may be in communication with a control system that regulates the distribution of power within the vehicle 10, such as to the electric drive motor, or a vehicle component or other accessories, or the like. For example, a high voltage battery may receive electrical energy from a plug-in source, and a low voltage battery may receive electrical energy from a solar source and from the higher voltage battery as needed.

The on-board charging module 14 changes AC power to DC power to recharge the energy storage device 16. Various types of on-board charging modules may be used. For example, an isolated on-board charging module may be used that employs some form of inductive charging wherein the charging module makes no physical connection between the AC electrical wiring and the energy storage device being charged. This type of charging module enables increased charging current and reduced charging times. Another example of a charging module that may be used is a non-isolated charging module that employs a direct electrical connection to an AC outlet's wiring.

The charger 14 has a generally rectangular shape having a first end 36, an opposed second end 38, a front surface 40, an opposed rear surface 42, a top surface 44, an opposed bottom surface 46, a first side surface 48, and an opposed second side surface 50. The charger 14 is coupled to the rechargeable energy storage device 16. In some embodiments, the charger 14 is coupled perpendicularly to the front end 18 and bottom surface 28 of the battery 16, as shown in FIG. 4B and 4C. The charger 14 charges the rechargeable energy storage device 16.

The charger 14 and rechargeable energy storage system 12 is mounted and coupled to the vehicle substructure, and tray 19, as shown in FIGS. 3 and 4A. In various embodiments, the charger 14 and rechargeable energy storage system 12 are physically and thermally integrated such that waste heat from the charger 14 can be harnessed to heat the rechargeable energy storage device 16. The integration of the charger 14 and rechargeable energy storage system 12 also enables the charger 14 and rechargeable energy storage system 12 to share power, such as, high voltage power, or the like, and electronics 52. The integration of the charger 14 and rechargeable energy storage system 12 also enables the charger 14 and rechargeable energy storage system 12 to share other components, devices, and systems, such as, a common cooling system 54 that can be opened and operated, anytime the rechargeable energy storage device 16 is in use and/or being charged and closed (valved) when charging, as shown in FIG. 4B.

Referring now to FIGS. 5-6, a schematic of a power electronic cooling loop 56 and a rechargeable energy storage system cooling loop 58 when the vehicle 10 is operating in a grid charge mode and in a drive mode, according to various embodiments is shown. The traction power inverter module, DC/DC converter, and motors are integrated by the power electronic cooling system 56. The power electronic cooling system 56 includes a power electronic radiator having a power electronic coolant loop including an electrical pump that toggles the loop between on and off positions. The rechargeable energy storage system 12 and on-board charging module 14 may be integrated by the rechargeable energy storage system cooling system 58. The rechargeable energy storage system cooling loop 58 includes a radiator having a cooling loop including an electrical pump that toggles the loop between on and off positions.

The power electronic devices and the rechargeable energy storage system 12 either generate or do not generate heat depending on the operation mode of the vehicle 10. For example, when the vehicle 10 is in a grid charge operation mode the DC/DC converter, rechargeable energy storage system 12, and on-board charging module generate heat while the traction power inverter module and motors do not, as shown in FIG. 5. When the vehicle 10 is in a drive operation mode, the traction power inverter module, DC/DC converter, motors, and rechargeable energy storage system 12 generate heat while the on-board charging module does not, as shown in FIG. 6.

By relocating the rechargeable energy storage device charging from the power electronic cooling loop 56 to downstream of the rechargeable energy storage system cooling loop 58, the charger waste heat can be reused to warm-up the rechargeable energy storage device 16 during cold climate conditions. This will help conditioning of the rechargeable energy storage device 16 while charging and thereby increase the EV range of the vehicle 10. The cooling pump overall energy consumption is assumed to be similar for both scenarios (i.e., grid charge mode and drive mode). Moreover, no further hardware changes are expected to be required for the rechargeable energy storage system thermal management system, as heat rejected by the rechargeable energy storage system 12 and the on-board charging module 14 while charging will still be less than the worst-case-scenario heat rejection while driving.

According to some embodiments, a bypass valve and associated plumbing can be added to the system to reduce the overall coolant pressure drop while driving (e.g., in the drive operational mode). The bypass valve can have various configurations, such as, an electronically controlled valve (e-valve), or the like.

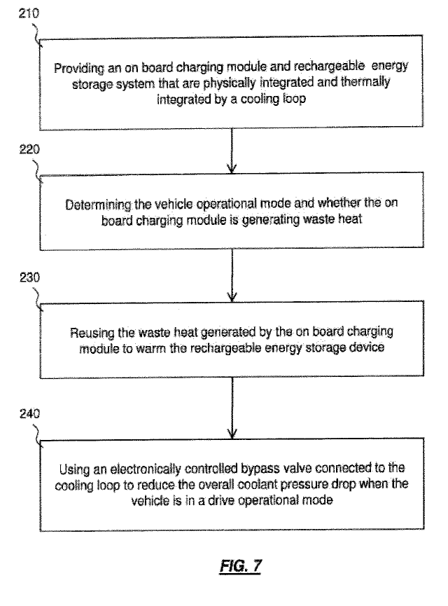

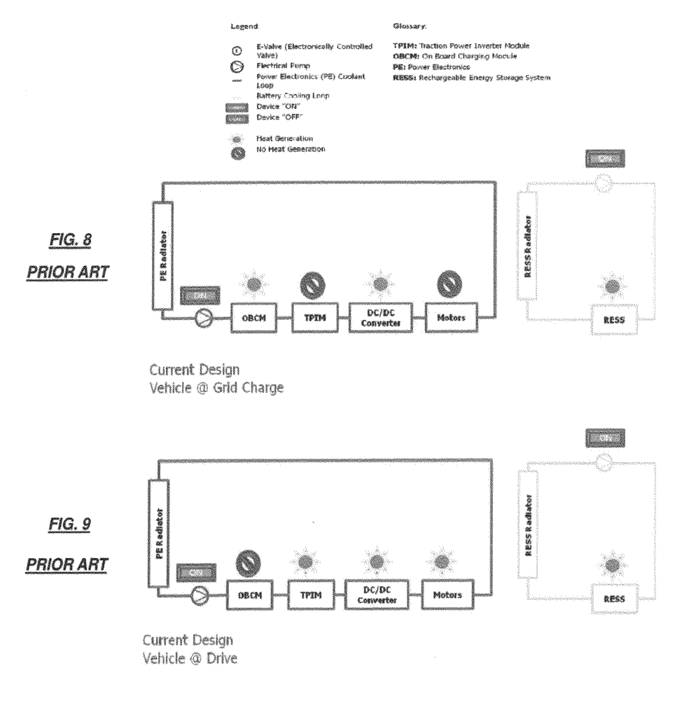

Referring now to FIG. 7, a method of regulating an integrated charger and rechargeable energy storage system (e.g., 12 in FIG. 4A) is shown. With reference to FIGS. 1-7, the method of regulating a charger and rechargeable energy storage system 12 for a vehicle 10 begins at block 210 and includes providing an on-board charging module 14 and a rechargeable energy storage system 12 and, wherein the on-board charging module 14 is physically integrated with the rechargeable energy storage system 12 and thermally integrated with the rechargeable energy storage system 12 by a battery cooling loop. The method advances to block 220 and includes determining the vehicle 10 operational mode and whether the on-board charging module 14 is generating waste heat. The method advances to block 230 and includes reusing the waste heat generated by the on-board charging module 14 to warm the rechargeable energy storage device 16. The method advances to block 240 and includes using an electronically controlled bypass valve connected to the cooling loop to reduce the overall coolant pressure drop when the vehicle 10 is in a drive operational mode.

Many modifications and variations of the present disclosure are possible in light of the above teachings. Therefore, within the scope of the appended claim, the present disclosure may be practiced other than as specifically described.

What is claimed is:

1. An energy management system for a vehicle, the system comprising:
a rechargeable energy storage system having a rechargeable energy storage device;
an on-board charging module thermally coupled to the rechargeable energy storage system such that at least some heat generated by the on-board charging module is transferred to the rechargeable energy storage device.

2. The system of claim 1,
wherein on-board charging module is thermally coupled to the rechargeable energy storage system via a cooling loop; and wherein the at least some heat generated by the on-board charging module is transferred to the rechargeable energy storage device via the cooling loop; and
wherein the on-board charging module is thermally integrated with the rechargeable energy storage system by a cooling loop such that waste heat generated by the on-board charging module is reused to warm the rechargeable energy storage device.

3. The system of claim 2, further comprising:
an electronically controlled bypass valve connected to the cooling loop to reduce overall coolant pressure drop when the vehicle is in a drive operational mode.

4. The system of claim 3, wherein the bypass valve comprises an electronically controlled bypass valve.

5. The system of claim 1, wherein the on-board charging module is physically integrated with the rechargeable energy storage system.

6. The system of claim 1, wherein the on-board charging module is connected to the rechargeable energy storage system.

7. The system of claim 1, wherein the at least some heat generated by the on-board charging module is transferred to the rechargeable energy storage device during a first vehicle operation mode, and wherein the at least some heat generated by the on-board charging module is transferred to the rechargeable energy storage device is not transferred during a second operation mode.

8. The system of claim 7, wherein the first vehicle operation mode comprises a charging mode in which the on-board charging module charges the rechargeable energy storage device.

9. The system of claim 7, wherein the second vehicle operation compromises a drive operation of the vehicle.

10. An energy management system, the system comprising:
an on-board charging module;
a rechargeable energy storage system having a rechargeable energy storage device;
wherein the on-board charging module is physically integrated with the rechargeable energy storage system; and
wherein the on-board charging module is thermally integrated with the rechargeable energy storage system by a cooling loop such that waste heat generated by the on-board charging module is reused to warm the rechargeable energy storage device.

11. The system of claim 10, further comprising:
an electronically controlled bypass valve connected to the cooling loop to reduce overall coolant pressure drop when the vehicle is in a drive operational mode.

12. The system of claim 11, wherein the bypass valve comprises an electronically controlled bypass valve.

13. An energy management method, the method comprising:
providing an on-board charging module and a rechargeable energy storage system having a rechargeable energy storage device, wherein the on-board charging module is physically integrated with the rechargeable energy storage system and thermally integrated with the rechargeable energy storage system by a cooling loop;
determining whether the vehicle is in a first vehicle operational mode or a second vehicle operational mode; and
transferring at least some heat generated by the on-board charging module to warm the rechargeable energy storage device when the vehicle is in the first vehicle operational mode.

14. The method of claim 13, further comprising:
using a bypass valve connected to the cooling loop to reduce the overall coolant pressure drop when the vehicle is in the second vehicle operational mode.

15. The method of claim 14, wherein the bypass valve comprises an electronically controlled bypass valve.
